(19) United States
(12) Patent Application Publication
(10) Pub. No.: US 2025/0269679 A1
(43) Pub. Date: Aug. 28, 2025

(54) Adjustable Modular Antler Display System with Removable Mounting Mechanism

(71) Applicant: Sabrina Marie Connolly, Pleasanton, CA (US)

(72) Inventor: Sabrina Marie Connolly, Pleasanton, CA (US)

(21) Appl. No.: 18/586,606

(22) Filed: Feb. 26, 2024

(51) Int. Cl. B44C 5/02

(52) U.S. Cl. CPC B44C 5/02

(57) ABSTRACT

The present invention provides a modular mounting apparatus for displaying antlers, comprising a false animal head structure with a removable skull cap piece. The skull cap features at least a pair of openings housing ball bearings, allowing for rotational movement and adjustable orientation of the antlers. Mounting insert pins attached to each ball bearing enable secure attachment of the antlers to the apparatus. A detachable mechanism facilitates the easy connection and removal of the skull cap from the false animal head structure, enhancing the display's versatility and ease of use. This apparatus offers an innovative solution for the aesthetically pleasing display of antlers, allowing for customization and adjustment without the need for actual animal parts, aligning with contemporary design preferences and ethical standards.

### FIELD OF INVENTION

The present invention relates generally to the field of trophy display systems, specifically to a modular apparatus designed for the mounting and display of antlers from various animals in a manner that allows for adjustable positioning and easy interchangeability of the displayed antlers without the use of real animal parts.

### BACKGROUND

Traditionally, hunters and collectors have relied on taxidermy to preserve and display deer, elk, moose, and other animals with antlers. This process involves the skilled craft of mounting or reproducing animals for display in a lifelike state. However, despite its widespread acceptance, traditional taxidermy faces several limitations and drawbacks that have prompted the search for innovative alternatives.

Firstly, traditional taxidermy is a labor-intensive process that requires a high level of skill and artistry. This not only makes it costly but also limits the accessibility for many enthusiasts who wish to display their trophies. Additionally, the permanence of traditional taxidermy does not afford the flexibility to easily change or update displays without undergoing another time-consuming and expensive process.

Moreover, concerns over sustainability and ethical considerations have led to a growing demand for alternatives that do not require the use of actual animal parts. This shift in consumer preference underscores the need for a more modern and versatile approach to trophy display that aligns with contemporary values.

Another significant challenge with traditional taxidermy is the space and weight considerations. Realistically mounted animals require substantial space for display and can be difficult to mount securely due to their weight. This poses a limitation for individuals with limited space or those who prefer a more minimalist aesthetic.

The introduction of antler mounting apparatuses presents a potential solution to these challenges. These systems aim to address the limitations of traditional methods by offering a more accessible, flexible, and ethical approach to displaying hunting trophies. However, existing modular systems often lack the aesthetic appeal and functional versatility desired by modern collectors. They may offer simplicity but fall short in providing a customizable and visually appealing display option that can adapt to the preferences and spaces of a wide range of users.

Against this backdrop, the development of a new mounting apparatus has been motivated by the desire to overcome the aforementioned drawbacks of traditional taxidermy and existing modular systems. This invention seeks to marry the aesthetic appeal of traditional displays with the flexibility, ethical considerations, and modern design sensibilities demanded by today's consumers. By addressing these needs, the invention aims to provide an innovative solution that enhances the experience of displaying trophies in a manner that is both artistically satisfying and aligned with contemporary values.

It is within this context that the present invention is provided.

### SUMMARY

The invention relates to a mounting apparatus designed for the display of antlers, incorporating a false animal head structure with a geometric design, a removable skull cap piece, ball bearings for rotational movement, mounting insert pins for antler attachment, and a detachable mechanism for connecting the skull cap to the head structure. This configuration allows for adjustable positioning of the antlers and offers a versatile and aesthetically pleasing alternative to traditional taxidermy methods.

In some embodiments, the mounting insert pins are designed to be removable from the ball bearings, enhancing the apparatus's flexibility by enabling the user to interchange antlers easily. This feature allows for the display to be updated or modified according to the user's preferences without the need for additional tools or complex procedures.

Further, in some embodiments, the top portion of the false animal head structure includes semi-spherical gaps specifically configured to receive the ball bearings. This design ensures a secure fit for the ball bearings while allowing for smooth and controlled rotational movement, thereby facilitating the precise adjustment of the antler's orientation.

In some embodiments, the apparatus incorporates a neck portion with a base designed for wall mounting, enabling the display to be securely attached to a vertical surface. This feature provides stability and showcases the antlers prominently, making it suitable for various settings, from homes to galleries.

Additionally, in some embodiments, the skull cap can be securely fastened to the false animal head structure using bolts, screws, or a locking mechanism. This secure attachment ensures the display's durability while still allowing for easy removal of the skull cap for maintenance or interchangeability of antlers.

In some embodiments, the mounting insert pins are designed with a first end that securely engages with the ball bearings and an opposing sharp end for insertion into the antlers. This design ensures a stable and secure connection between the antlers and the display apparatus, preventing slippage or misalignment.

In some embodiments, the false animal head structure and the skull cap are constructed from lightweight materials such as aluminum, expanded polystyrene, or a composite material. The use of these materials reduces the overall weight of the apparatus, facilitating easier installation and reducing strain on mounting surfaces.

In some embodiments, the ball bearings are made from corrosion-resistant materials, including stainless steel or a polymer composite. This choice of materials ensures the longevity and durability of the apparatus, even in environments with fluctuating humidity or temperature.

Lastly, in some embodiments, the apparatus is designed to be configurable to accommodate antlers from different species of animals, such as deer, elk, and moose. This is achieved by providing mounting insert pins of various sizes and shapes, suitable for the specific antler configurations of each species, thereby increasing the apparatus's versatility and appeal to a wide range of users.

### BRIEF DESCRIPTION OF THE DRAWINGS

Various embodiments of the invention are disclosed in the following detailed description and accompanying drawings.

FIG. 1A illustrates a frontal isometric view of an example antler mounting apparatus according to the present invention.

FIG. 1B illustrates a top down isometric view of the apparatus.

FIG. 1C shows a front perspective isometric view of the same apparatus.

FIG. 2 shows a rear perspective view of the apparatus in a disassembled state.

FIG. 3 shows a rear isometric view of the apparatus in an assembled state.

FIG. 4A and FIG. 4B show perspective and side views of the skull cap piece close up.

FIG. 4C shows the skull cap piece in an exploded disassembled state.

FIG. 5A and FIG. 5B shows perspective and top-down isometric views of the head of the animal with the skull cap piece removed.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “false animal head structure” refers to any representation or imitation of an animal's head that is designed for the purpose of displaying antlers. This structure may be made from various materials, including but not limited to metals, plastics, composites, or any combination thereof, and is not limited to any specific animal species. The design and construction of the false animal head structure are such that it can support the weight of the antlers and allow for their adjustable orientation through associated mechanisms.

The term “skull cap piece” as described herein encompasses any detachable component designed to fit onto the top portion of the false animal head structure. This component is characterized by having at least a pair of openings through which ball bearings are positioned. The skull cap piece serves as a platform for mounting the antlers and allows for their rotation and adjustment. Materials for the skull cap piece can include, but are not limited to, aluminum, polymers, and composites, chosen for their durability, weight, and aesthetic qualities.

For the purposes of this disclosure, “ball bearings” are understood to include any spherical or semi-spherical elements that facilitate the rotational movement of the attached antlers. These elements are made from materials selected for their strength, durability, and resistance to corrosion, such as stainless steel, ceramics, or corrosion-resistant alloys. The ball bearings are designed to fit snugly within the openings of the skull cap piece while allowing for free rotation within their confines.

“Mounting insert pins” as used herein refer to components that are designed to attach antlers to the ball bearings. These pins may have various ends for engaging with both the ball bearings and the antlers, including but not limited to sharp, threaded, or barbed ends, to ensure a secure attachment. The materials for the pins include metals, alloys, or any suitable material capable of supporting the weight of the antlers and withstanding the forces applied during adjustment.

The phrase “means for detachably connecting” encompasses any mechanism or system that allows for the temporary attachment and removal of the skull cap piece from the false animal head structure. This may include, but is not limited to, mechanical fasteners such as bolts and screws, clips, magnetic systems, or locking mechanisms designed for easy operation while ensuring secure attachment.

### Description of Drawings

The present invention relates to a mounting apparatus for displaying antlers, designed to provide an aesthetically pleasing and versatile alternative to traditional taxidermy. This apparatus is characterized by a false animal head structure with a geometric design, onto which a skull cap piece can be removably coupled. The skull cap includes at least a pair of openings, each housing a ball bearing that allows for the rotational movement of attached antlers, thereby enabling adjustable orientation of the antlers for optimal display. Mounting insert pins, attached to each ball bearing, facilitate the secure attachment of antlers to the apparatus. Additionally, the invention features a mechanism for detachably connecting the skull cap piece to the false animal head structure, allowing for easy interchangeability and maintenance of the display.

This invention addresses the need for a display method that is both flexible in the presentation of antlers and non-reliant on the actual animal parts, aligning with ethical considerations and modern design preferences. The apparatus is designed to accommodate antlers from various species, such as deer, elk, and moose, providing a universal solution for enthusiasts and collectors.

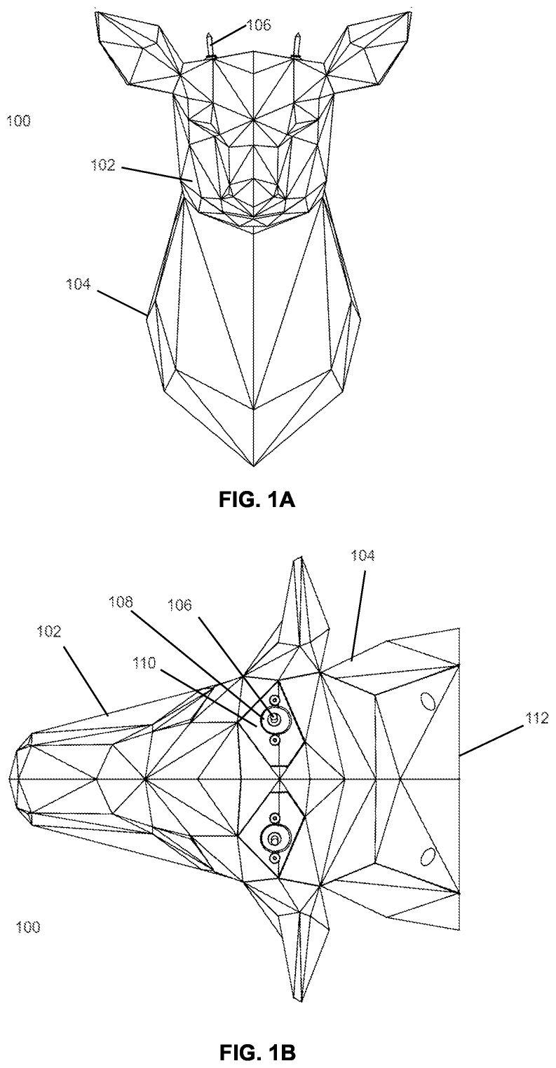

FIG. 1A illustrates a frontal isometric view of an example antler mounting apparatus 100 according to the present invention. It comprises a geometrically designed false animal neck 104 and head structure 102 of a deer. At the top portion of the head 102 a pair of antler inserts 106 protrude upward, ready for antlers to be mounted on them.

FIG. 1B illustrates a top down isometric view of the apparatus 100, showing the head 102, neck 104, and inserts 106. From this angle, it can be seen that the inserts 106 are mounted to a pair of ball bearings 108 secured within a skull cap piece 110 at the top of the head. The flat surface of the base 112 of the apparatus used for mounting to a wall is also visible.

FIG. 1B shows a front perspective isometric view of the same apparatus 100.

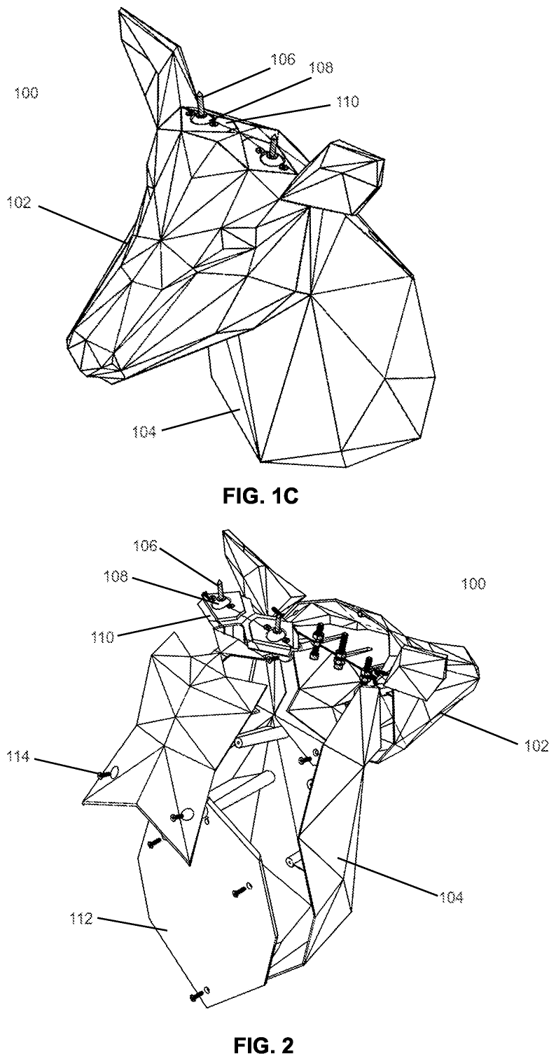

FIG. 2 shows a rear perspective view of the apparatus 100 in a disassembled state, with screws 114 visible that are used for securing the modular structure together. It can be seen that the head and neck structure is hollow, and the skull cap piece 110 can be seen removed from the head 102.

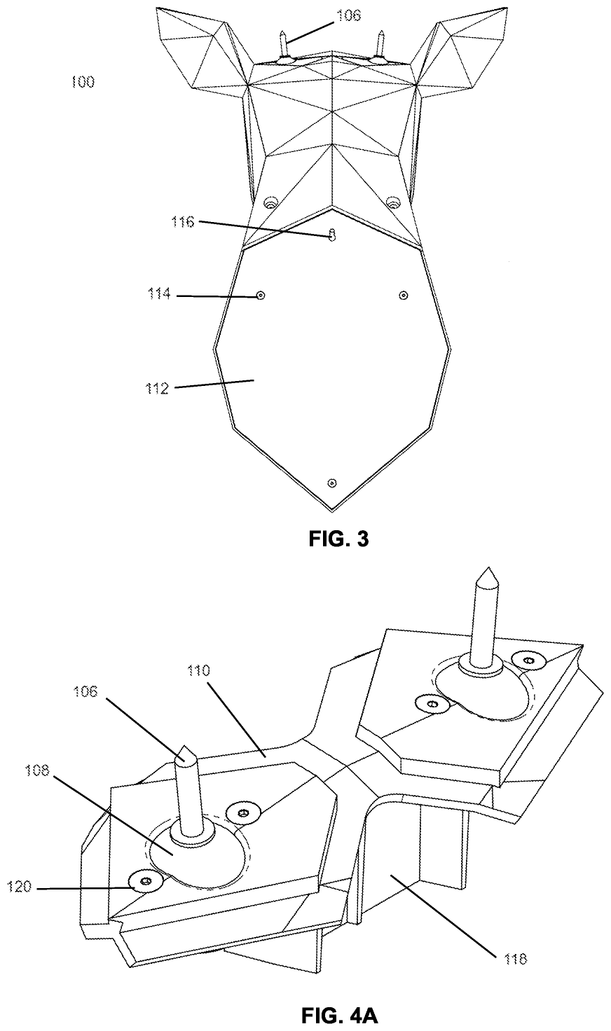

FIG. 3 shows a rear isometric view of the apparatus 100 in an assembled state. The base 112 can be seen to have a wall mounting keyhole opening 116 for receiving a hook or the like.

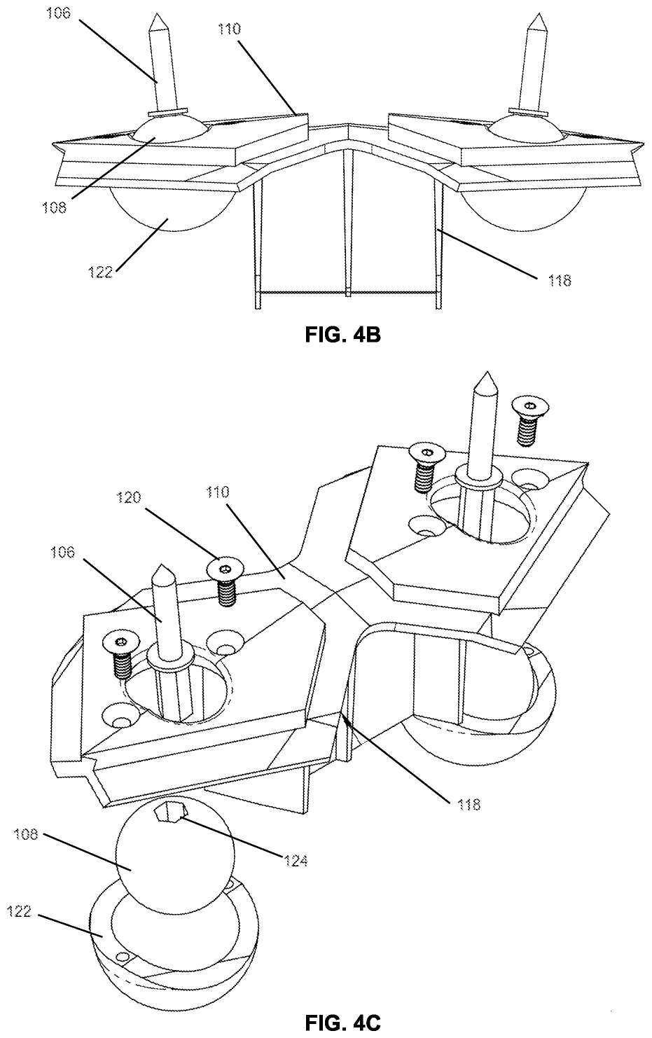

FIG. 4A and FIG. 4B show perspective and side views of the skull cap piece 110 close up. In this example configuration, the skull cap piece comprises a pair of semi-spherical hollow shells 122 which together with the skull cap piece body 110 form a housing for the ball bearings 108. The shells 122 are secured to the skull cap piece with screws 120. The skull cap piece also comprises a coupling mechanism 118 for securing the assembly on the top portion of the animal head structure 102.

FIG. 4C shows the skull cap piece in an exploded disassembled state. It can be seen that the ball bearings 108 have an opening 124 into which the inserts can be inserted or removed.

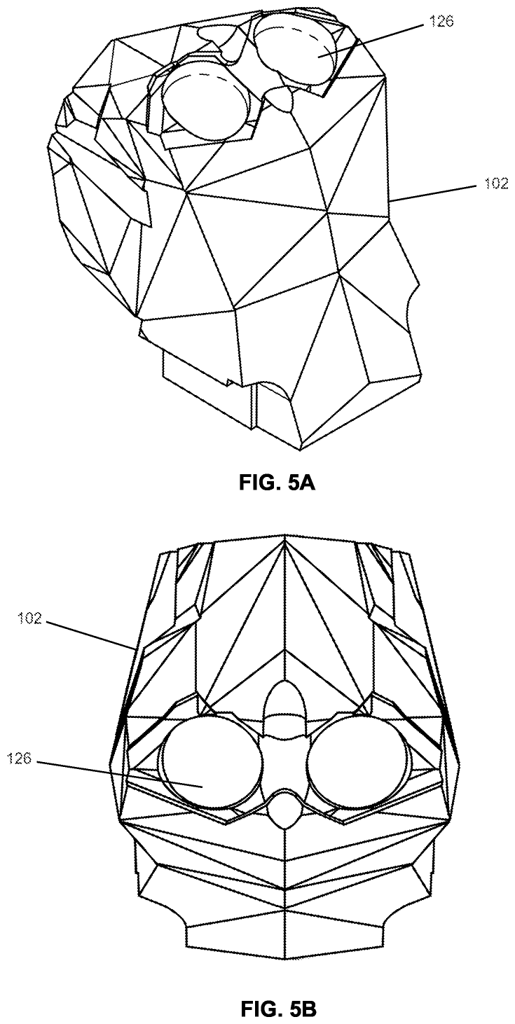

Finally, FIG. 5A and FIG. 5B shows perspective and top-down isometric views of the head 102 of the animal with the skull cap piece removed. In this example configuration it can be seen that the top portion 126 is shaped with two circular grooves and a set of angular grooves which together specifically form a shape configured to receive the skull cap piece and ball bearing assembly.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the mounting apparatus of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A mounting apparatus for displaying antlers, comprising:
a false animal head structure, the structure comprising a top portion;
a skull cap piece removably coupled to the top portion of the false animal head structure, the skull cap including at least a pair of openings;
a pair of ball bearings, each ball bearing disposed within a respective opening of the skull cap, wherein the diameter of each opening is smaller than the diameter of the respective ball bearing, thereby allowing the ball bearing to be retained within the opening while permitting rotational movement of the ball bearing;
a pair of mounting insert pins, each mounting insert pin attached to a respective ball bearing and configured for insertion into an antler to secure the antler to the false animal head structure; and
a means for detachably connecting the skull cap piece to the false animal head structure.

2. The mounting apparatus of claim 1, wherein the false animal head structure has a geometric design.

3. The mounting apparatus of claim 1, wherein the mounting insert pins are removable from the ball bearings to allow for interchangeability of the antlers.

4. The mounting apparatus of claim 1, wherein the top portion of the false animal head structure further comprises at least a pair of semi-spherical gaps configured to receive the ball bearings.

5. The mounting apparatus of claim 1, wherein the false animal head structure further comprises a neck portion extending downwards form the head, the neck portion including a base with a flat surface configured for attachment to a wall mount, facilitating the display of the apparatus on a vertical surface.

6. The mounting apparatus of claim 1, wherein the skull cap is fastened to the false animal head structure using at least one of bolts, screws, or a locking mechanism, providing secure attachment and easy removal of the skull cap for interchangeability of antlers or maintenance.

7. The mounting apparatus of claim 1, wherein the mounting insert pins comprise a first end shaped to securely engage with the ball bearings and an opposing sharp end for insertion into the antlers.

8. The mounting apparatus of claim 1, wherein the false animal head structure and the skull cap are fabricated from a lightweight material selected from the group consisting of aluminium, expanded polystyrene, or a composite material.

9. The mounting apparatus of claim 1, wherein the ball bearings are made from a corrosion-resistant material, including but not limited to stainless steel or a polymer composite

10. The mounting apparatus of claim 1, wherein the apparatus is configurable to accommodate antlers from different species of animals, including but not limited to deer, elk, and moose, by providing mounting insert pins of various sizes and shapes suitable for the specific antler configurations of each species.
